(19) United States
(12) Patent Application Publication
(10) Pub. No.: US 2002/0029187 A1
(43) Pub. Date: Mar. 7, 2002

(54) Electronic marketplace

(76) Inventors: John J. Meehan, Rye, NH (US); Patrick J. Meehan, Kittery, ME (US)

Correspondence Address: NUTTER MCCLENNEN & FISH LLP, ONE INTERNATIONAL PLACE, BOSTON, MA, 02110, US

(21) Appl. No.: 09/949,277

(22) Filed: Sep. 7, 2001

Related U.S. Application Data
(60) Provisional application No. 60/231,188, filed on Sep. 7, 2000.

(51) Int. Cl. G06F 17/60

(52) U.S. Cl. 705/37

(57) ABSTRACT

A method and system for facilitating the purchase and sale of goods and services utilizing a communications network is provided. In general, a host site having a web address accessible to users of the Internet is provided. The host site can be accessed directly using the Internet, or using a software program installed on the hard drive of a user's computer. Sellers can list items for sale on the host site while connected to the Internet, or while off-line using the software program. Each item listed for sale is stored in a file in a database of item listings, and each file contains a deal dialogue box pertaining to the item. Prospective buyers can access the database and search for or browse through the items for sale. If the prospective buyer is interested in an item, the buyer can submit questions and/or offers to the seller. Each question and/or offer, along with the seller's response, can be posted in the deal dialogue box for other users of the site to view.

### CROSS REFERENCE TO RELATED APPLICATIONS

This application claims priority from U.S. Provisional Patent Application Serial No. 60/231,188, filed on Sep. 7, 2000, entitled “Electronic Auction,” which is expressly incorporated by reference herein.

### BACKGROUND OF THE INVENTION

The present invention relates generally to an electronic marketplace, and, more particularly, to a method and system for an electronic marketplace utilizing a communications network.

Electronic marketplaces are well known in the art, allowing users to interactively participate in the purchase and sale of an item without having to leave their homes. Online marketplace companies are expanding rapidly, since inventories, warehouses, and large support staff are no longer required. Current electronic marketplaces follow a typical format. The seller posts an item for sale at auction along with a brief description. Prospective buyers then bid on the item based on the seller's description, and a picture of the item, if provided. Once the auction period ends, the auction closes and a transaction occurs between the buyer and seller.

The details of the transaction between the bidders and the seller are generally governed by a specific set of trading rules as determined by the auctioneer. For example, sealed bid auctions do not allow users to view the bids submitted until the conclusion of the auction. Bidders, therefore, are not given an opportunity to outbid other users. Moreover, a bidder has no way of determining whether or not their bid is sufficient or even falls within the market value of the item. Ascending bid auctions, on the other hand, allow each bidder to view the current highest bid. This allows bidders to continue to resubmit bids, and, consequently, drive the market price of the item up. Some auction systems allow a bidder to submit a maximum bid which is not disclosed to the seller or to other bidders. The auctioneer will then continue to bid on behalf of the bidder at a set amount above the current highest bid until the bidder's maximum bid has been reached. This allows the bidder to continuously outbid other bidders without having to manually resubmit a new bid. In open auction systems, all prior bids are displayed with the item. The users can view the bid history and, in some cases, see which user placed the bid. The users are generally identified by a user identification code or an electronic email address.

While electronic auctions provide a huge marketplace for buyers and sellers to meet, current auction systems are not without their drawbacks. The auction process is extremely depersonalized and access to information is also usually limited to the description provided by the seller. Take, for example, a seller who wants to sell a 1950 painting by a particular artist. The seller writes a brief description of the painting and attaches a photograph. A prospective buyer, interested in the painting, sees the photograph and reads the seller's description. The buyer would typically consider certain relevant factors, including information about the seller, other bidders, and the painting itself, to determine how much to bid. For example, information about the artist, the condition of the painting, and where the painting is from would affect the value of the painting. Information about the seller, such as whether or not the seller is a collector, how long the seller has owned the painting, how much the seller knows about the painting, and what the seller expects to receive for the painting, could be used to assess a bid amount. The prospective buyer may also want to know why other bidder's want to buy the painting. Since current auction systems revolve mostly around the bidding process, however, prospective buyers may be prevented from obtaining this information. Bidders have no way of determining the mind set of other bidders, or even of the seller. Moreover, the seller's honesty about the item is hidden behind a description. Most auctions do not provide a guarantee that the seller's statements are true, thereby forcing buyers either to take a risk in bidding on an item, or to withdraw from the auction all together.

Some auction sites do allow potential buyers to contact the sellers via electronic mail (e-mail). However, most potential buyers and sellers do not want to disclose their personal e-mail addresses due to the large number of unwanted e-mails (spam) that are sent once an address is disclosed on the Internet.

Current electronic auction processes also prevent sellers from having any control over the sale. Once a seller agrees to sell an item, they are bound to the terms set forth by the auction host site. Such terms usually deter a seller from withdrawing an item from the auction once the minimum sale price is met by a potential buyer. If the seller does withdraw an item, can receive a so-called “negative report” and may also be required to pay a fee to the host of the auction site. Moreover, the seller cannot select the buyer or the sale price. The auction does not end when the seller accepts a bid, but rather continues until the close of the auction period.

Accordingly, there is need for an electronic marketplace system that is more personalized and reliable, which provides sellers with more control over the selling process, and which provides prospective buyers with access to information about the seller, the item, and the other potential buyers.

### SUMMARY OF THE INVENTION

The present invention is directed to a system and method for facilitating the purchase and sale of goods and services utilizing a communications network. In general, a host site having a web address accessible to users of the Internet is provided. Sellers can list items for sale on the host site either through direct access or, in an exemplary embodiment, using a software program downloaded from the host site or otherwise provided to the user. The software program allows users to communicate with the host site and with other users via the host site. Each item listed for sale is stored in a file in a database of item listings. Each file further contains a deal dialogue box pertaining to the item. Prospective buyers can access the database and search for or browse through the items for sale. If the prospective buyer is interested in an item, the buyer can submit questions and/or offers to purchase the item to the seller. Each question and/or offer, along with the seller's response, can be posted in the deal dialogue box for other users of the site to view.

In one embodiment, each item listing can include descriptive information and asking price information for each item to be sold. The items listed in the database can be categorized, enabling prospective buyers to search for items in specific categories. Prospective buyers can also register with the host site in at least one collector category of interest, entering a profile for each category, which can contain a description of items of interest to the collector. The buyers are notified each time a new item is listed in their registered category of interest. In addition, sellers can browse through the list of buyers registered in the collector categories, thereby identifying potential buyers before listing a new item for sale on the host site.

In another embodiment, prospective buyers and sellers are required to register with the host site in order to submit items for sale, questions, and/or offers. Registration can be completed at the host site, or can be completed after installation of a software program for providing access to the host site. In a preferred embodiment, prospective buyers and sellers are assigned or can select a user identification code when the prospective buyer or seller registers. Any questions, offers, and responses submitted by the registered buyers and sellers are posted with the user identification code of the registered buyer or seller who submitted the question, offer, or reply. This allows users of the site to link the questions, offers, and replies to the specific buyers or sellers. In a further embodiment, the sellers and/or buyers may selectively determine which questions, offers, and responses are posted in the deal dialogue box.

In yet another embodiment, each registered seller and buyer is assigned a user mailbox. All questions, offers, and replies are forwarded to the appropriate user mailbox when submitted. In a further embodiment, registered sellers are notified when new questions and/or offers are forwarded to the seller's user mailbox, and registered buyers are notified when a seller reply has been forwarded to the buyer's user mailbox.

One advantage of the present invention is that prospective buyers can converse with sellers, asking the seller questions about the item or making offers, and both sides of the discussion will appear in the deal dialogue box. However, personal email addresses of the parties involved (sellers and prospective buyers) are not revealed, unless otherwise specified by the user, allowing parties to remain anonymous until the sale is complete. Another advantage of the present invention is that the deal dialogue box provides all prospective buyers with additional information on the item being sold. The deal dialogue box will also enable the venue provider to review the transaction to both improve the site and safeguard the transaction process. Yet another advantage is that users can register in a collector category of interest, thereby allowing sellers to locate potential buyers directly on the host site.

### BRIEF DESCRIPTION OF THE DRAWINGS

The invention will be more fully understood from the following detailed description taken in conjunction with the accompanying drawings, in which:

FIG. 1 is a flow diagram of the main electronic marketplace in accordance with the present invention;

FIG. 2 is a flow diagram of the registration process in accordance with the present invention;

FIG. 3 is a flow diagram of the buying process in accordance with the present invention; AND

FIG. 4 illustrates a sample deal dialogue box in accordance with one embodiment of the present invention.

### DETAILED DESCRIPTION OF THE INVENTION

The present invention relates to a method and system for electronically facilitating the purchase and sale of goods and services utilizing a communications network. In general, the method and system utilize a host site having a database of items for sale by specific sellers. The database is maintained by the host site, and can also be stored on the hard drive of a user's computer. Each item for sale is stored in a file in the database, and each file contains a deal dialogue box pertaining to the item. The deal dialogue box tracks some or all of the dialogue between users relating to the item. Prospective buyers can submit questions and/or offers to the seller of an item. All questions and offers, along with the sellers' replies, are posted in the deal dialogue box for users of the site to view. The seller may, however, have the option to select which communications are posted in the deal dialogue box.

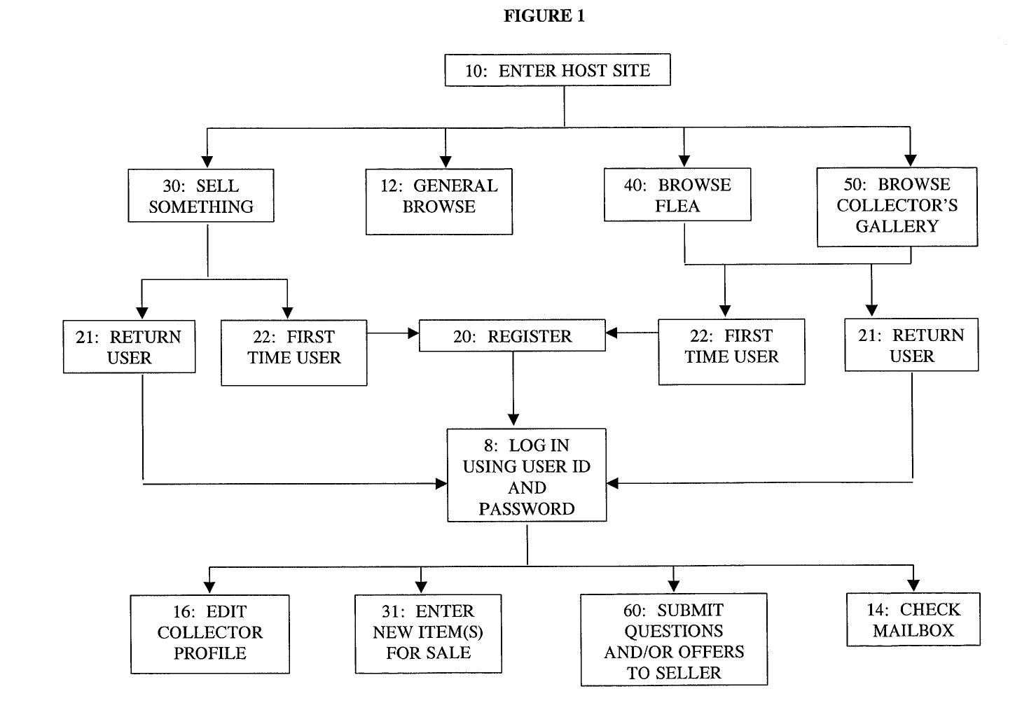

FIG. 1 illustrates an overview flow chart of the present invention in the context of various pages on the host site 10. The present invention preferably begins with the user entering a host site 10 to gain access to the database. The host site and the database can be accessed using a web address accessible to users of the Internet. In addition or alternatively, the host site and the database can be accessed using a software program installed on the hard drive of a user's computer. The software program maintains a backup copy of the host site and the database on the hard drive of the user's computer. This allows the user to access the backup host site and backup database without connecting to the Internet. The software program can also be used to connect to the main host site and the main database over a communications network. Once the host site is accessed, users can perform functions over a communications network, or optionally on the hard drive of the user' computer. Each time a user connects to the host site using a communications network, the host site and database can be updated to include any changes made to the backup host site and backup database stored on the user's hard drive.

In a preferred embodiment, the host site only maintains an abbreviated text-only file for each item for sale. The full item listings are stored on the hard drive on the user's computer. When a user connects to the host site using a communications network, the software program will download all new item listings directly from the hard drive of other user's computers who are also connected to the host site. This is commonly referred to as peer-to-peer communication and advantageously reduces the need for a central system having an extensive database by allowing users to communicate directly with each other.

A person having ordinary skill in the art will appreciate that the terms “host site” and “database” as used herein are intended to include a host site and database stored over a communications network and a host site and database stored on the hard drive of a user's computer. Thus, any function performed by a user can be performed off-line using a software program installed on a user's computer, or while connected to a communications network either directly through the host site or using a software program installed on a user's computer.

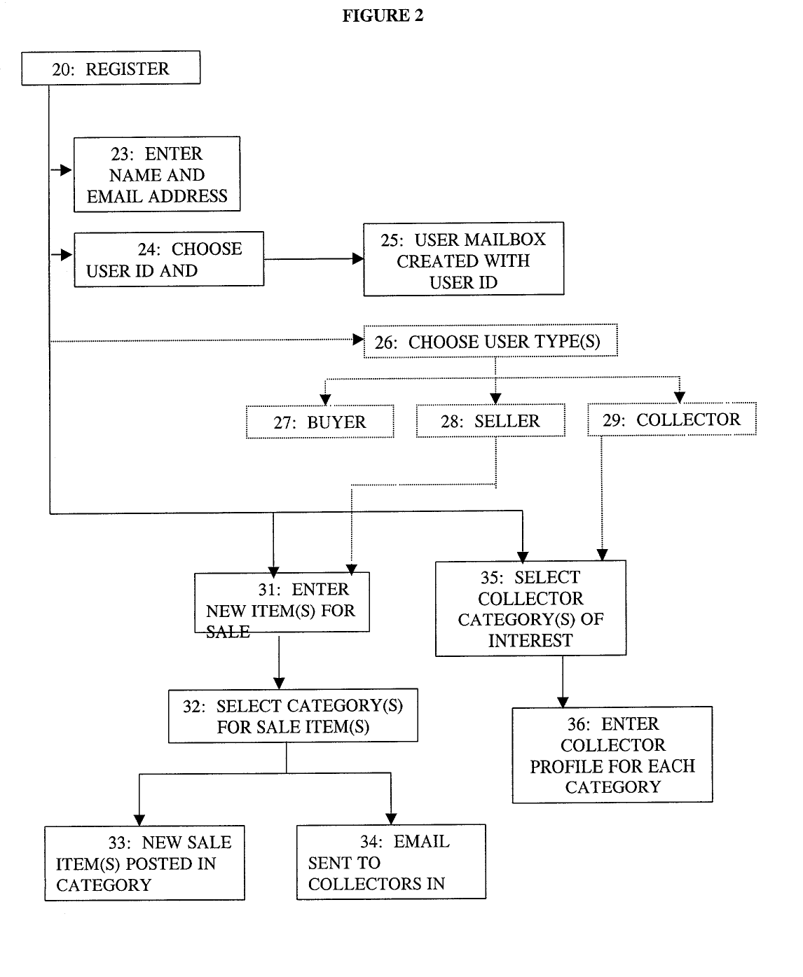

As shown in FIG. 1, once the user enters the host site 10, the user has the option of performing several functions, including selling an item 30, browsing the flea market 40, browsing the collector's gallery 50, or generally browsing the site 12. Prior to performing some or all of the functions, the user may be required to register 20 with the host site 10 through an exemplary registration process as shown in FIG. 2. In a preferred embodiment, users can always browse the flea market 40, browse the collector's gallery 50, and browse the general site 12 without logging in 8. The flea market 40 contains a database of items for sale by specific sellers. The collector's gallery 50 contains a database of collector-users registered in categories of interest. More particularly, the database contains a file for each category of interest, which includes a list of potential buyers registered in that category. Potential sellers can browse through the database to identify potential buyers before listing a new item for sale on the host site.

Registration 20 can be completed on the host site 10 over a communications network, or alternatively can be completed during or after installation of the software program. Once the user is registered 20, the user can log in 8 to the host site 10 with appropriate user identification and a password. Return users 21 and users connecting to the host site 10 through the software program can bypass the registration process 20. Once logged in 8, the user can edit his or her user profile 16, which is created during registration 20, enter new items for sale 31, submit questions and/or offers 60 to sellers, and check for new mail in his or her user mailbox 14.

FIG. 2 illustrates an exemplary registration process 20. The user must enter his or her name and email address 23. The user selects or is assigned a user identification code, and the user selects a password 24. In one embodiment, the user identification code is used to create a user mailbox 25. In another embodiment, the user chooses a user type 26. Exemplary user types include a buyer-user 27, a seller-user 28, and a collector-user 29. Users can also register as a member of a particular user-group or sub-group, wherein group members can restrict access to item listings posted by the group.

Once the registration is completed, the user can select collector categories of interest and enter a profile 36 for each category 35. The profile 36 can contain a description of items of interest to the collector, and the requirements that must be met before the collector will buy an item. For example, the collector-user 29 can specify a preference for items of a certain type that were made in a selected time frame. Preferences can also be based on the condition or quality of the item.

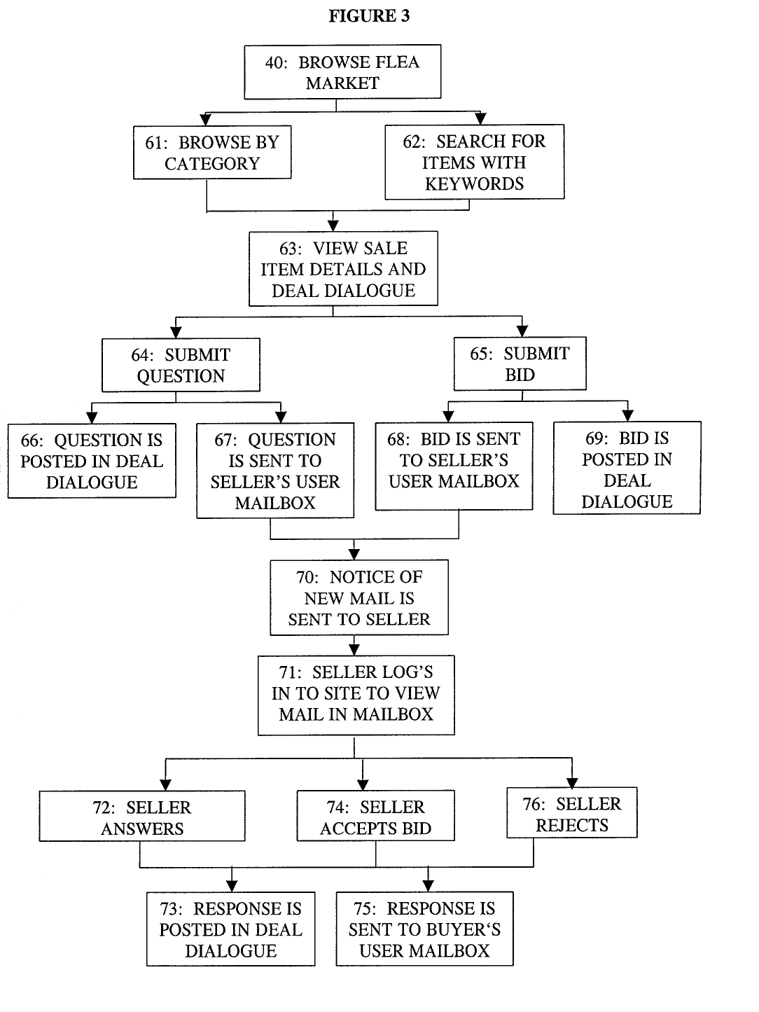

As further illustrated in FIG. 3, users also have the option to enter new items for sale 31. The seller-user can prepare a written description of the object, including any information the user deems useful. In a preferred embodiment, the software program installed on the hard drive of the user's computer is used to prepared an item listing. Item listing templates can be provided to assist the user. The user can include photographs of the item with the listing, and can optionally select a category 32 for each sale item. Once a new item for sale is entered 31 and the category is selected 32, the new sale item is posted 33 in the category. An email can be sent to collector-users 29 registered in that category, notifying the collector that a new sale item has been posted which may meet the collector's profile 36.

In an exemplary embodiment, the item listing is stored on the hard drive of the user's computer, and only the text portion of the listing is uploaded to the host site when the user connects to the host site using a communications network. User's can access the text-only version of the listing when the seller-user who listed the item is not logged in to the host site. When the seller-user who listed the item is logged in to the host site, the full listing, including photographs, can be transferred directly to the hard drive of the computers of all others users who are logged in at the same time.

A person having ordinary skill in the art will appreciate that a user is not required to register as a collector-user 29, a seller user 28, or a buyer 27 prior to selecting categories of interest, entering new items for sale, or performing any other function. Moreover, users registered as a particular type of user are not limited to that user type. For example, users registered as a seller-user are not limited to only selling items, but may also collect and buy items. All registered users, regardless of user type, are given the option to enter new items for sale 31, and to select collector categories of interest and enter a profile 36 for each category 35.

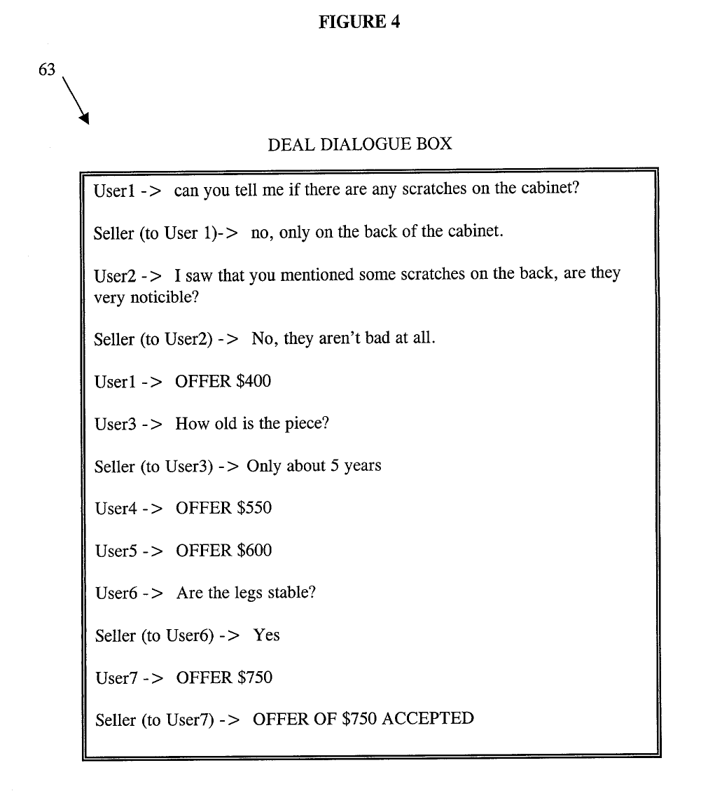

FIG. 3 illustrates the buying process. Prospective buyers can browse the flea market 40 by category 61, or they can search for items with key words 62. Once a prospective buyer finds an item, he or she can view the item description as well as information on the item that is present in the deal dialogue box 63. By way of non-limiting example, FIG. 4 illustrates a deal dialogue box 63 for a sample item listing. As shown, the deal dialogue box 63 is a text box which contains some or all of the dialogue between the seller and users. The deal dialogue box 63 can be viewed with the item description, or can be included on a separate page which the user has the option to open during viewing of the item listing.

In order to submit an offer 65 or present a question 64 to the deal dialogue box 66, the prospective buyer may be required to log in 12 with the site 10, or register 20 with the site if the buyer is not already registered. If a prospective buyer submits a question 64, the question can be posted in the deal dialogue box 66 and, preferably, it is sent to the seller's user mailbox 67. A notice of new mail is then sent 70 by the site 10 to the seller's personal email address (which was submitted during the registration process). The seller can then log in 12 to the site to view mail in the seller's site-provided mailbox 71. Then, if desired, the seller can submit answers to the questions 72 that are posed through the deal dialogue box, and the seller's reply is then posted in the deal dialogue box 73. In one embodiment, the seller's reply can also be sent to the user mailbox 75 of the individual posing the question. A notice of new mail can be sent by the site to the individual posing the question notifying the individual that a reply has been sent to the individual's user mailbox 75.

The seller and/or the buyer can have the option to select which communications between the seller and the buyer are posted in the deal dialogue box. For example, the buyer can submit a confidential question to the seller without having the question posted in the deal dialogue box. Alternatively or optionally, the seller can decide whether or not the buyer's question and/or the seller's response is posted in the deal dialogue box.

The user follows the same process to submit an offer 65. The offer is sent to the seller's user mailbox 68 and optionally posted in the deal dialogue box 69. In a preferred embodiment, a notice of new mail is sent to the seller 70. The seller logs in with the site to view the mail in the seller user's mailbox 71, and can either accept the offer 74 or reject the offer 76. The seller's response can be posted in the deal dialogue box 73 and an email can be sent to the user's user mailbox 75.

For the sake of convenience, the term “Internet” is used herein to encompass the global network commonly known as the Internet or World Wide Web, as well as intranets, LANs, WANs, dial-up or other types of electronic bulletin boards, and any other wired or wireless communications networks or media. Moreover, “computers” can be of any type available in the art, as well as any other device (e.g., cell phone, pager, or television set) permitting communications over the Internet (or other communications network or media) as defined above.

The features and other details of the invention will now be more particularly described and pointed out in the claims. It will be understood that the particular embodiments of the invention are shown by way of illustration and not as limitations of the invention. One of ordinary skill in the art will readily appreciate that minor variations can be made to the method and system described herein without departing from the scope of the invention. All references and documents cited herein are expressly incorporated by reference in their entirety.

What is claimed is:

1. A method for facilitating an electronic marketplace utilizing a communications network, comprising:
providing a host site having a web address accessible to users of the Internet;
receiving at least one item listing from at least one seller;
creating a database of item listings accessible through the host site on the Internet, the database having a file for each item wherein each file contains a deal dialogue box pertaining to each item;
enabling prospective buyers to submit questions and/or offers to the seller of an item;
posting the questions and/or offers in the deal dialogue box for the file applicable to the item;
receiving replies to the questions and/or offers from the sellers; and
posting the seller replies in the deal dialogue box.

2. The method of claim 1, wherein each item listing includes descriptive information and asking price information for each item to be sold by the seller.

3. The method of claim 1, further comprising:
enabling a plurality of prospective buyers to register with the host site as registered buyers; and
enabling the registered buyers to register in at least one category of interest.

4. The method of claim 3, further comprising notifying registered buyers when a new item is listed in the buyer's registered category of interest.

5. The method of claim 1, further comprising:
enabling a plurality of users to register with the host site as registered users; and
assigning a user identification code for each registered user.

6. The method of claim 5, wherein the questions and/or offers are posted with the user identification code of the registered user who submitted the question and/or bid, and the replies are posted with the user identification code of the registered user who submitted the reply.

7. The method of claim 1, further comprising:
enabling a plurality of prospective users to register with the host site as registered users; and
creating a user mailbox for each registered user.

8. The method of claim 7, further comprising forwarding the questions and/or offers to the user mailbox of the appropriate registered user of the item.

9. The method of claim 8, further comprising notifying the appropriate registered usres that a question and/or bid has been forwarded to their user mailbox.

10. The method of claim 7, further comprising forwarding the user replies to the user mailbox of the appropriate registered user who submitted the question and/or bid.

11. The method of claim 10, further comprising notifying the appropriate registered users that a user reply has been forwarded to their user mailbox.

12. The method of claim 1, further comprising enabling sellers to accept or reject offers.

13. The method of claim 1, further comprising enabling users to selectively choose which questions and/or offers and which replies are posted in the deal dialogue box.

14. A method for facilitating an electronic marketplace utilizing a communications network, comprising:
providing a host site having a web address accessible to users of the Internet;
enabling a plurality of prospective sellers to register with the host site;
receiving at least one item listing from at least one of the registered sellers;
creating a database of item listings accessible through the host site on the Internet, the database having a file for each item wherein each file contains a deal dialogue box pertaining to each item;
enabling prospective buyers to access the database of item listings;
enabling prospective buyers to submit questions and/or offers regarding one of the items;
forwarding the questions and/or offers to the appropriate registered seller of the item;
posting the questions and/or offers in the deal dialogue box for the file applicable to the item;
receiving seller replies to the questions and/or offers from the appropriate registered seller;
forwarding the seller replies to the appropriate prospective buyer who submitted the question and/or bid; and
posting the seller replies in the deal dialogue box.

15. The method of claim 14, wherein each item listing includes descriptive information and asking price information for each item to be sold by the registered seller.

16. The method of claim 14, further comprising:
enabling a plurality of prospective buyers to register with the host site; and
enabling the registered buyers to register in at least one category of interest.

17. The method of claim 16, further comprising notifying registered buyers when a new item is listed in the buyer's registered category of interest.

18. The method of claim 16, further comprising:
creating a database of potential buyers, the database having a file for each category of interest, wherein each category of interest contains a list of potential buyers registered in that category; and
enabling the plurality of prospective sellers to access the database of potential buyers;
wherein the plurality of prospective sellers can browse through the categories of interest to identify potential buyers before submitting a new item listing.

19. The method of claim 14, further comprising before the step of enabling prospective buyers to submit questions and/or offers regarding one of the items, enabling a plurality of prospective buyers to register with the host site.

20. The method of claim 19, wherein each registered seller and each registered buyer is assigned a user identification code.

21. The method of claim 20, wherein the questions and/or offers are posted with the user identification code of the registered buyer who submitted question and/or bid, and the replies are posted with the user identification code of the registered seller who submitted the reply.

22. The method of claim 19, further comprising creating a user mailbox for each registered user.

23. The method of claim 22, further comprising:
forwarding the questions and/or offers to the user mailbox of the appropriate registered seller of the item; and
forwarding the seller replies to the user mailbox of the appropriate registered buyer who submitted the question and/or bid.

24. The method of claim 23, further comprising:
notifying the appropriate registered sellers that a question and/or bid has been forwarded to their user mailbox ; and
notifying the appropriate registered buyers that a seller reply has been forwarded to their user mailbox.

25. The method of claim 14, further comprising enabling sellers to accept or reject offers.

26. The method of claim 14, further comprising enabling users to selectively choose which questions and/or offers and which replies are posted in the deal dialogue box.

27. A method for facilitating the purchase and sale of goods and services utilizing a communications network, comprising:
providing a host site having a web address accessible to users of the Internet;
providing a database of item listings maintained by the host site, the database having a file for each item wherein each file contains a deal dialogue box pertaining to each item;
providing a software program for accessing the host site, for enabling prospective buyers to submit questions and/or offers to a seller of an item, and for enabling sellers to submit replies to the questions and/or offers;
receiving questions and/or offers from prospective buyers;
posting the questions and/or offers in the deal dialogue box for the file applicable to the item;
receiving replies to the questions and/or offers from the sellers; and
posting the seller's replies in the deal dialogue box.

28. The method of claim 27, wherein the software program is adapted to enable users to access the database of item listings prior to connecting to a communications network.

29. The method of claim 28, wherein users can prepare questions and/or offers and replies to questions and/or offers prior to connecting to the host site.
